(19) United States
(12) Patent Application Publication
(10) Pub. No.: US 2025/0324999 A1
(43) Pub. Date: Oct. 23, 2025

(54) PROCESS FOR THE PREPARATION OF CHEWING GUM AND THE PRODUCTS OBTAINED

(71) Applicant: Perfetti Van Melle S.P.A., Lainate (Milano) (IT)

(72) Inventors: Evsen Suleymanoglu, Milano (IT); Maurizio Deleo, Lainate (Milano) (IT); Alessio Tulli, Origgio (VA) (IT); Fabio Allasia, Lainate (MI) (IT); Andrea Sarrica, Lainate (Milano) (IT)

(73) Assignee: Perfetti Van Melle S.P.A., Lainate (Milano) (IT)

(21) Appl. No.: 18/873,585

(22) PCT Filed: Jun. 22, 2023
(86) PCT No.: PCT/IB2023/056464

§ 371 Date: Dec. 10, 2024

(30) Foreign Application Priority Data
Jun. 27, 2022 (IT) 102022000013546

(51) Int. Cl. A23G 4/08; A23G 4/10

(52) U.S. Cl. CPC A23G 4/08; A23G 4/10

(57) ABSTRACT

Disclosed is a process for the preparation of chewing gum containing a wholly natural gum base. The resulting product is characterised by a hardness equivalent to that of chewing gums made with a synthetic gum base.

The invention relates to a process for the preparation of chewing gum containing a wholly natural gum base. The resulting product is characterised by a hardness equivalent to that of chewing gums made with a synthetic gum base.

### PRIOR ART

The use of a natural gum base, namely one made from solely natural ingredients and substances, to make chewing gum, is known. In particular, the extract of the Manilkara tree, belonging to the Sapotaceae family originating from the American continent, commonly known as chicle, is known to have been used to make chewing gum in the past. When chicle was used to make chewing gum, a gum base consisting solely of chicle could not be used because the end product was extremely hard to chew, due to its physical and organic characteristics.

The chewing gum industry therefore developed gum base formulations using ingredients including synthetic elastomers (such as butyl rubber, styrene-butadiene rubber and poly-isobutylene), synthetic resins (such as rosin esters, polyvinyl acetate and terpene resins) and synthetic or natural plasticisers (such as oils, fats and triacetin), which give the end product the necessary softness, making it chewable and usable by the consumer.

Many types of chewing gum made from various ingredients, depending on the outlet market, are currently available. A wide range of chewing gums can be obtained by using gum bases with various characteristics, which the skilled person can suitably select from gum bases with a low, intermediate or high degree of hardness, to obtain chewing gums of the desired hardness for chewing.

In view of the increasing amount of attention being given to the environment and to research into foods whose composition is based as far as possible on solely or mainly natural ingredients, the need is felt for chewing gums that use a gum base made solely from natural ingredients.

However, the manufacture of said gums involves considerable difficulties, because the natural gum base tends to make them excessively hard, making them difficult to chew and causing the gum to break into smaller pieces, leading to an unpleasant sensation for and the risk of accidental swallowing. Attempts to combine waxes such as candelilla wax with chicle have produced unsatisfactory results.

### DESCRIPTION OF THE INVENTION

The present invention provides a process for the preparation of chewing gum which allows a gum base consisting solely of natural ingredients, in particular based on chicle, to be used, resulting in an end product whose hardness can be modulated, and which is comparable with chewing gums made from a synthetic gum base.

This aim was achieved by combining a natural gum base containing no polymers (synthetic elastomers and synthetic resins) with a solution of pectin and sugar or polyols. A chewing gum with the desired hardness characteristics can thus be obtained, in particular a gum having a hardness and palatability comparable with those of chewing gums made from a gum base consisting of synthetic ingredients. The plasticising action of a solution of pectin and sugar or polyols on a gum base mass consisting solely of natural ingredients is unknown; pectin has been used as an ingredient in the formulation of chewing gums, but for purposes different from those of the present invention. For example, GB2013473 discloses the use of pectin as a humectant additive, while JP60054644 describes large-scale use of pectin as a dietary fibre, up to 80% by weight of the gum base, for the sole purpose of making a diet product with a high fibre content. EP252874 discloses a gum base containing a polysaccharide, such as pectin in granulated form, having the function of thickener. US20120087874 discloses the use of pectin in solution, together with an agent described as a “heating” agent, with which the pectin interacts to trigger a sensation of heat in the oral cavity.

In a first aspect thereof, the invention relates to a process for the preparation of chewing gum which comprises:
a) adding sugars and/or polyols to the natural gum base mass containing no synthetic polymers;
b) mixing the mass obtained in a) with an ungelled aqueous solution of pectin, sucrose or polyols having a concentration measured by refractometer ranging between 3° and 50° Brix, the pectin: polyols or sucrose weight ratios ranging between 50:50 and 95:5;
c) adding essential oils, flavourings and optionally other ingredients, and mixing until a homogeneous mass is obtained;
d) processing the mass to make chewing gum of the desired weight and shape.

In a second aspect thereof, the invention relates to the chewing gums obtained by said process.

The natural gum base used according to the invention comprises chicle, preferably in an amount exceeding 50%, more preferably exceeding 75%, and even more preferably exceeding 90% of the total weight of the gum base.

The solution of ungelled pectin, sucrose or polyols is added to the gum base mass, sugars, polyols and other ingredients in a percentage ranging between 3 and 7% by weight of the end product.

The solution of pectin, sugar and/or polyols preferably has a concentration measured by refractometer of 43°±1° Brix and a pectin: sugars and/or polyols weight ratio of 80:20.

The pectin can be a high methoxyl, low methoxyl or amidated pectin. Highly purified pectins, which meet the purity criteria for additive E440, are available on the market. Crude extracts or preparations such as citrus fruit fibres or apple peel preparations, which naturally contain pectin, can alternatively be used.

“Ungelled pectin” means a pectin which has not undergone treatments or conditions that induce gelation, for example by using combinations of sugars and acidifying additives or using calcium salts. The ungelled pectin solution according to the invention therefore does not contain acidifying additives or calcium salts.

The aqueous solution of pectin, sucrose or polyols preferably contains a pH-adjusting agent, such as trisodium citrate, in a percentage ranging from 0.5 to 1% by weight of the solution.

The sugars and polyols are selected from sucrose, glucose, fructose, allulose, tagatose, maltose, isomaltulose, isomalt, maltitol, lactitol, sorbitol, xylitol, mannitol, erythritol and combinations thereof. The sugar used to make the mixture can be selected from sucroses of various origins: cane, beet, agave or coconut. It may be unrefined (such as brown, raw, muscovado or demerara sugar) or refined (white sugar). The sugar used is preferably in the crystalline state, in the state of a fine powder. Icing sugar (sucrose) is preferably used.

Examples of polyols which can be used as an alternative to sugars comprise isomalt, maltitol, lactitol, sorbitol, xylitol, mannitol and erythritol. The polyols are preferably used in crystalline form of various particle sizes.

The sugars or polyols are typically used in an amount ranging from 15% to 85% by weight of the end product, preferably from 50% to 70% by weight of the end product.

Syrups such as glucose syrup, invert sugar, agave syrup and maltitol syrup can also be used.

In a particular embodiment of the invention, the chewing gum does not contain said sugar syrups.

In one embodiment of the invention, the chewing gum does not contain said sugar syrups, but contains sucrose ranging from 50% to 70% by weight of the finished product.

Natural flavourings can be used, preferably consisting of essential oil in an amount ranging between 1% and 2% by weight of the total mass, and more preferably amounting to 1.5%.

The additional ingredients can be present in an amount ranging between 0.1% and 10% by weight of the total.

The mixture of sugar or polyols, pectin and optionally trisodium citrate or another similar salt is prepared by dissolving said ingredients in water at a temperature greater than 70° C., preferably between 90° and 98° C., mixed until the desired concentration is obtained, and then cooled to room temperature.

According to a preferred aspect, step a) is conducted at a temperature lower than the melting point of the natural gum base. The mass of natural gum base, preferably chicle, is placed in a mixer at a temperature lower than 80° C., generally between 25 and 50° C., to prevent the gum base from dissolving, and typically mixed for 10-600 seconds, usually for 60-180 seconds.

Mixing of the gum base mass with the solution of pectin, sugar and/or polyols (step b) typically has a duration ranging between 10 seconds and 1200 seconds. Flavourings, and optionally other ingredients, can be added before or after said step.

The resulting mass is then processed by conventional methods, until individual pieces of the desired weight and shape are formed, using a specific set of knives. For example, the mass can be transferred to an extruder for extrusion of a sheet or rope of chewing gum, which can also contain a solid, viscous liquid or powdered filling.

The chewing gums can then be coated; the sugar-coating can be hard, crunchy, soft, opaque or transparent.

The chewing gum obtained by the process described is a further object of the invention, and is characterised by a gum base content consisting of natural gum base containing no synthetic polymers amounting to 20% to 40% by weight of the end product, 3 to 7% by weight of the end product of an aqueous solution of pectin, sucrose or polyols in weight ratios ranging between 50:50 and 95:5, having a concentration measured by refractometer ranging between 3° and 50° Brix, natural flavourings amounting to 1% to 2% by weight, and sugars and/or polyols amounting to up to 100% by weight of the end product. The hardness of the chewing gums according to the invention typically ranges between 690 and 350 N*mm.

The invention is illustrated in detail in the following examples.

### EXAMPLES

The following formulations are made by the process according to the invention. The individual pieces were not sugar-coated, had a rectangular shape, a weight of 1.1 g per piece and a height ranging between 5.1 and 5.5 mm.

### Examples 1-6

TABLE 1
examples 1-4: compositions with natural gum

| | Example 1 | Example 2 | Example 3 | Example 4 |
|---|---|---|---|---|
| | (reference) | (invention) | (invention) | (invention) |
| Ingredients | % | % | % | % |
| Natural gum base | 35 | 35 | 35 | 35 |
| containing chicle | | | | |
| Sugar: | 63.5 | 60.5 | 59.5 | 56.5 |
| Pectin and sugar | 0 | 3 | 4 | 7 |
| solution 80:20, 43° Brix | | | | |
| Natural peppermint | 1.5 | 1.5 | 1.5 | 1.5 |
| flavouring | | | | |
| Total | 100 | 100 | 100 | 100 |
| Notes | Reference | Sample made | Sample made | Sample made |
| | sample | by the process | by the process | by the process |
| | according to | according to | according to | according to |
| | the prior art | the invention | the invention | the invention |
| | with natural | with the | with the | with the |
| | gum base | minimum | optimum | maximum |
| | | amount of | amount of | amount of |
| | | pectin solution | pectin solution | pectin solution |
| Instrumental evaluation | YES | YES | YES | YES |
| Sensory evaluation 1 | YES | YES | YES | YES |
| Sensory evaluation 2 | NO | NO | YES | NO |

TABLE 2
examples of compositions 5 and 6 with artificial gum

| | Example 5 | |
|---|---|---|
| | (reference) | Example 6 |
| Ingredients | % | (reference) |
| Artificial gum base A | 35 | |
| Artificial gum base B | | 35 |
| Sugar | 53.5 | 53.5 |
| Glucose syrup | 10 | 10 |
| Natural peppermint | 1.5 | 1.5 |
| flavouring | | |
| | 100 | 100 |
| | Reference sample | Reference sample |
| | according to the prior art | according to the prior art |
| | with artificial gum base of | with artificial gum base of |
| | medium hardness | high hardness |
| Instrumental evaluation | NO | NO |
| Sensory evaluation 1 | NO | NO |
| Sensory evaluation 2 | YES | YES |

### Instrumental Evaluation

The following equipment and settings were used for the instrumental evaluation.

The hardness parameter can be evaluated by instrumental methods or sensory methods.

### Memmert IPP 55 Incubator

Set-up=24° C.
   Xtplus texture analyser
Load cell 500 N
Probe: 8 mm (steel cylinder)
Trigger Force: 0.2N
Pre Speed: 5.4 mm/min
Test Speed: 100.2 mm/min-STRAIN 55%
Post test Speed: 100.2 mm/min

The test samples are conditioned in the incubator for 24 h and then analysed with the texture analyser. For each sample tested, 32 pieces were used, the hardest and softest piece were discarded, and the hardness was calculated as the mean work (N*mm) necessary for penetration of the specimen under the conditions described.

TABLE 3
instrumentally measured hardness of the compositions
of examples 1-4 containing natural gum

| | Example 1 | Example 2 | Example 3 | Example 4 |
|---|---|---|---|---|
| Ingredients | (reference) | (invention) | (invention) | (invention) |
| Mean work | 750 | 691 | 555 | 353 |
| (N*mm) | | | | |
| Pectin:sugar | 0 | 3 | 4 | 7 |
| solution | | | | |
| 80:20, 43° Brix | | | | |

An increase in the pectin solution reduces the hardness of the samples made by the process according to the invention.

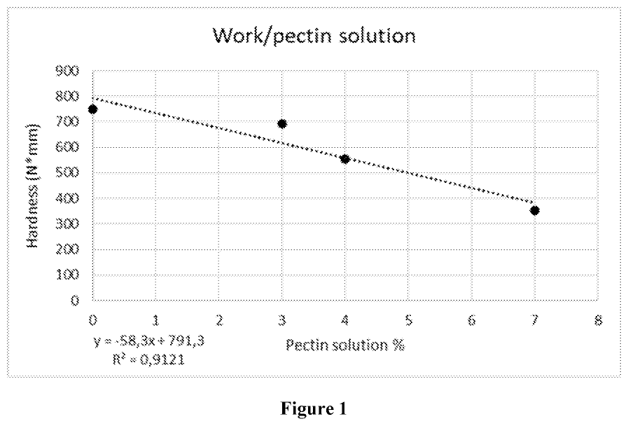

The correlation is also illustrated in FIG. 1, which shows that an increase in the pectin solution leads to a linear reduction in hardness.

### Sensory Evaluation N1

Samples 1-4 were evaluated by four expert tasters to evaluate their acceptability in terms of hardness (Table 4).

TABLE 4
acceptability evaluation of samples containing natural gum

| | Example 1 | Example 2 | Example 3 | Example 4 |
|---|---|---|---|---|
| Examples | (reference) | (invention) | (invention) | (invention) |
| Result of | Too hard | Borderline | Optimum | Borderline |
| tasting | | acceptable due | hardness | acceptable due |
| | | to almost | | to almost |
| | | excessive | | excessive |
| | | hardness | | softness |

### Sensory Evaluation N2

Eight expert tasters were involved in the second sensory evaluation. Each taster received three blinded samples, and asked to chew them for five minutes and evaluate the samples using the following terms: “less hard”, “medium hardness”, “harder”, both at the start of and during chewing. Said descriptors were assigned the scores 1, 2 and 3 respectively, and the values were multiplied by the number of times each descriptor was associated with a sample. For each sample, the sum of the products represents the total hardness, shown in Table 5.

TABLE 5
sensory evaluation of hardness during chewing

| | Example 3 | Example 5 | Example 6 |
|---|---|---|---|
| Examples | (invention) | (reference) | (reference) |
| Total hardness at | 19 | 15 | 14 |
| start of chewing | | | |
| Total hardness | 12 | 15 | 21 |
| during chewing | | | |
| Mean hardness | 15.5 | 15 | 17.5 |

Example 3 according to the invention came closer to Reference Example 5 (made with an artificial gum base of medium hardness) than Example 6. In general, Example 3 proved slightly harder at the start of chewing and slightly less hard during chewing than both the reference samples. When the mean of the two hardnesses was calculated, Example 3 proved slightly harder then Example 5, and slightly less hard than Example 6. In conclusion, Example 3, made with natural gum base by the process according to the invention, has a hardness comparable with that of the comparative examples.

1. A process for the preparation of chewing gum comprising:
a) adding sugars and/or polyols to the mass of natural gum base, free of synthetic polymers;
b) mixing the mass obtained in (a) with an aqueous solution of ungelled pectin, sucrose or polyols of concentrations measured by refractometer ranging between 3° and 50° Brix, the pectin: polyols or sucrose weight ratios ranging between 50:50 and 95:5;
c) adding essential oils, flavourings and any other ingredients and mixing until a homogeneous mass is obtained;
d) processing the mass into chewing gum of the desired weight and shape.

2. A process according to claim 1 wherein step (a) is carried out at a temperature below the melting point of the natural gum base.

3. A process according to claim 1 wherein the natural gum base comprises chicle in an amount higher than 50% of the total weight of the gum base.

4. A process according to claim 1 wherein the ungelled solution of pectin, sucrose or polyols is added in an amount ranging between 3 and 7% by weight of the end product.

5. A process according to claim 1 wherein the solution of pectin, sugar and/or polyols has a concentration measured by refractometer of 43°±1° Brix and a pectin: sugars and/or polyols weight ratio of 80:20.

6. A process according to claim 1 wherein the pectin is a high methoxyl, low methoxyl, or amidated pectin.

7. A process according to claim 1 wherein the aqueous solution of ungelled pectin, sucrose or polyols contains a pH-adjusting agent.

8. A process according to claim 7 wherein the pH-adjusting agent is trisodium citrate in an amount ranging from 0.5 to 1% of the solution.

9. A process according to claim 1 wherein the sugars and polyols are selected from sucrose, glucose, fructose, allulose, tagatose, maltose, isomaltulose, isomalt, maltitol, lactitol, sorbitol, xylitol, mannitol, erythritol and combinations thereof.

10. Process according to claim 1 wherein the mixing of step b) has a duration ranging between 10 seconds and 1200 seconds.

11. A chewing gum wherein the gum base consists of natural gum base free of synthetic polymers in the proportion of 20% to 40% by weight, 3 to 7% by weight of an aqueous solution of ungelled pectin, sucrose or polyols in ratios ranging between 50:50 and 95:5 by weight, having a concentration measured by refractometer ranging between 3° and 50° Brix, natural flavourings between 1% and 2% by weight, and sugars and/or polyols up to 100% by weight.

12. A chewing gum according to claim 11 characterised by hardness ranging between 690 and 350 N*mm.

13. The process according to claim 3, wherein the natural gum base comprises chicle in an amount higher than 75% of the total weight of the gum base.

14. A process according to claim 3 wherein the natural gum base comprises chicle in an amount higher than 90% of the total weight of the gum base.
